(19) United States
(12) Patent Application Publication
(10) Pub. No.: US 2015/0337176 A1
(43) Pub. Date: Nov. 26, 2015

(54) FLAME RETARDANT ADHESIVE

(71) Applicant: 3M INNOVATIVE PROPERTIES COMPANY, St. Paul, MN (US)

(72) Inventors: Thu-Van T. Tran, Maplewood, MN (US); Ross E. Behling, Woodbury, MN (US); Peter J. Harrison, Hudson, WI (US); Soyoung Kim, Fremont, CA (US)

(21) Appl. No.: 14/653,079

(22) PCT Filed: Dec. 13, 2013
(86) PCT No.: PCT/US2013/074960

§ 371 Date: Jun. 17, 2015

Related U.S. Application Data
(60) Provisional application No. 61/739,876, filed on Dec. 20, 2012.

(51) Int. Cl. C09J 7/02

(52) U.S. Cl. CPC C09J 7/0246; C09J 7/0282; C09J 151/003

(57) ABSTRACT

Flame retardant adhesive are described. The flame retardant adhesives include at least 93 wt. % an acrylic copolymer. This acrylic copolymer comprises the polymerization reaction product of 50 to 92 wt. % of at least one alkyl (meth)acrylate monomer, 3 to 25 wt. % of at least one nitrogen-containing monomer, and 5 to 25 wt. % of at least one vinyl-functional poly(methacrylate) macromer. Articles incorporating such adhesive are also described.

### FIELD

The present disclosure relates to flame retardant adhesive comprising an acrylic copolymer, and articles incorporating such adhesives.

### SUMMARY

Briefly, in one aspect, the present disclosure provides a flame-retardant adhesive comprising at least 93 wt. % an acrylic copolymer comprising the polymerization reaction product of (i) 50 to 92 wt. % of at least one alkyl (meth)acrylate monomer, 3 to 25 wt. % of at least one nitrogen-containing monomer, and 5 to 25 wt. % of at least one vinyl-functional poly(methacrylate) macromer. In some embodiments, the acrylic copolymer may include 0 to 1 wt. % of a carboxylic acid group containing monomer; and/or 0 to 2 wt. % of a flame retardant. In some embodiments, the flame-retardant adhesive comprises at least 95 wt. % of the acrylic copolymer.

In some embodiments, the acrylic copolymer comprises at least 75 wt % of the alkyl (meth)acrylate monomer. In some embodiments, the acrylic copolymer comprises 5 to 20 wt. % of the nitrogen-containing monomer. In some embodiments, the acrylic copolymer comprises 5 to 15 wt. % of the vinyl-functional poly(methacrylate) macromer. In some embodiments, the acrylic copolymer comprises 0 to 0.5 wt. % of the carboxylic acid group containing monomer. For example, in some embodiments, the acrylic copolymer comprises at least 98 wt. % an acrylic copolymer comprising the polymerization reaction product of at least 85 wt. % of the alkyl (meth)acrylate monomer, 5 to 15 wt. % of the nitrogen-containing monomer, 5 to 10 wt. % of the vinyl-functional poly(methacrylate) macromer, 0 to 0.1 wt. % of the carboxylic acid group containing monomer; and 0 to 0.2 wt. % of a flame retardant. In some embodiments, the flame-retardant adhesive comprises 0 to 0.5 wt. % of the flame retardant.

In some embodiments, at least one alkyl (meth)acrylate monomer is a C4-C8 alkyl (meth)acrylate monomer. In some embodiments, at least one nitrogen-containing monomer is an acrylamide. In some embodiments, at least one vinyl-functional poly(methacrylate) macromer is a vinyl-functional poly(methyl methacrylate) macromer.

In another aspect, the present disclosure provides a flame-retardant tape comprising a substrate and a flame-retardant adhesive according to any of the various embodiments described herein. In some embodiments, the substrate comprises a urethane. In some embodiments, the tape passes FAR 25.853 when tested according to the Burn Test Procedure.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates an exemplary flame retardant article according to some embodiments of the present disclosure.

### DETAILED DESCRIPTION

Flame retardants are chemicals added to other materials such as thermoplastics, thermosets, textiles, adhesives and coatings to impart flame retardancy, e.g., to inhibit or resist the spread of fire. Flame retardants are used in a variety of products such as car interiors, rugs, furniture, electrical cable insulation, adhesives, carpeting, and aircraft interiors. As one example, for aircraft interiors, specifically carpeting, polyurethane is used as moisture barrier backing. This moisture barrier is adhered to a composite panel using a pressure sensitive adhesive. The polyurethane can be made flame retardant by adding a brominated hydrocarbon with a small amount of antimony trioxide. The pressure sensitive adhesive may also include flame retardants such that the overall structure meets the required flammability standards.

Flame retardants can be separated into several classes including: minerals such as aluminum hydroxide and magnesium hydroxide; halogenated compounds such as decabromodiphenyl ether and brominated carbonate oligomers; and organophosphorous compounds such as tri-o-cresyl phosphate. The addition of mineral flame retardants can affect the optical clarity of the adhesive. Also, most mineral flame retardants are not soluble and often require special dispersing equipment. Halogenated flame retardant systems offer the advantage of low level loadings, e.g., 5%. However, many countries require no halogens in their products due to the potential toxicity of halogen vapor released during the combustion. Non-halogenated systems such as those containing organophosphorous compounds generally require loadings of up to 20% or more. Such high loadings can adversely affect physical properties and product performance. For example, high levels of phosphorous compounds can result in weak interfacial bonding between the backing and adhesive.

Significant effort has focused on identifying alternative flame retardants or mitigating the deficiencies of existing flame retardants. Surprisingly, the present inventors discovered pressure sensitive adhesives that are inherently flame retardant and do not require the addition of any flame retardants. In addition, in some embodiments, these adhesives can impart flame retardancy to the substrates to which they are bonded, even though such substrates do not incorporate any flame retardants.

Generally, the adhesives of the present disclosure comprise an acrylic copolymer. The acrylic copolymer comprises the polymerization reaction product of at least one alkyl (meth)acrylate monomer, a nitrogen-containing monomer, and a mono-functional poly(methacrylate) macromer.

As used herein, the term “(meth)acrylate refers to one or both of an acrylate and its corresponding methacrylate. For example, butyl (meth)acrylate refers to butyl acrylate, butyl methacrylate, and combinations thereof. Generally, any known (meth)acrylate may be used including alkyl and aryl (meth)acrylates. In some embodiments, an alkyl (meth)acrylate is used. In some embodiments, the alkyl group contains 1 to 18 carbon atoms, i.e., a C1 to C18 alkyl (meth)acrylate. In some embodiments, at least one alkyl (meth)acrylate monomer is a C1 to C12, e.g., a C1 to C8, e.g., a C4-C8 alkyl (meth)acrylate. In some embodiments, at least one alkyl (meth)acrylate monomer is a C8 alkyl (meth)acrylate, e.g., isooctyl acrylate and/or 2-ethyl hexyl acrylate. In some embodiments, at least one alkyl (meth)acrylate monomer is a C1 to C4 alkyl (meth)acrylate. In some embodiments, e.g., when copolymerized with a C8 alkyl (meth)acrylate, at least one alkyl (meth)acrylate monomer is a C4 alkyl (meth)acrylate, e.g., butyl acrylate. In some embodiments, an aryl (meth)acrylate may be used, e.g., phenyl (meth)acrylate and benzyl (meth)acrylate.

Generally, any known nitrogen-containing monomer or combination of nitrogen-containing monomers may be used, provided such monomer(s) are capable of co-reacting with at least one of the (meth)acrylate monomers and/or the vinyl-functional poly(methacrylate) macromer. In some embodiments, the nitrogen-containing monomer has a single ethylenically unsaturated group and a nitrogen-containing group or a salt thereof. The ethylenically unsaturated group can be a (meth)acryloyl group or a vinyl group (i.e., CH2═CH2- group) that is not a (meth)acryloyl group.

Examples of the nitrogen-containing groups include, but at not limited to, primary amido groups, secondary amido groups and tertiary amido groups. Exemplary nitrogen-containing monomers with primary amido groups include acrylamide and methacrylamide (collectively, (meth)acrylamide). Exemplary nitrogen-containing monomers with secondary amido groups include diacetone acrylamide and N-alkyl (meth)acrylamides such as N-methyl acrylamide, N-ethyl acrylamide, N-isopropyl acrylamide, tert-octyl acrylamide, and N-octyl acrylamide. Exemplary nitrogen-containing monomers with a tertiary amido group include, but are not limited to, N-vinyl caprolactam, N-vinyl-2-pyrrolidone, acryloyl morpholine, and N,N-dialkyl acrylamides such as N,N-dimethyl acrylamide, N,N-diethyl acrylamide, N,N-dipropyl acrylamide, and N,N-dibutyl acrylamide.

Generally, the acrylic copolymers of the present disclosure comprise the polymerization reaction product of at least one mono-functional poly(methacrylate) macromer.

The functional group provides the reaction site allowing the mono-functional poly(methacrylate) macromer to copolymerize with the other constituents of the acrylic copolymer. Generally, upon polymerization the functional group is incorporated into the backbone of the copolymer, leading to a pendant poly(methacrylate) macromer. In some embodiments, the functional group is an ethylenically unsaturated group. Suitable functional groups include a (meth)acryloyl group or a vinyl group (i.e., CH2═CH2- group) that is not a (meth)acryloyl group.

The poly(methacrylate) is a macromer comprising methacrylate repeat units. Methacrylate monomers suitable for preparing the poly(methacrylate) include alkyl methacrylates such as methyl, ethyl, n-butyl, isobutyl, cylcohexyl, and isobornyl methacrylate. Both homopolymers and copolymers of such alkyl methacrylates may be used. In some embodiments, the poly(methacrylate) macromer may also include repeat units derived from acrylates including alkyl acrylates such as methyl and ethyl acrylate, as well as other comonomers.

Generally, the macromer has a weight average molecular weight, Mw, of at least 2,000 and no greater than 35,000. In some embodiments, Mw is at least 4,000, e.g., at least 6,000. In some embodiments, Mw is no greater than 25,000, e.g., no greater than 15,000.

Suitable monofunctional poly(methacrylate) macromers include those available under the trade name ELVACITE from Lucite International, Canada. Exemplary poly(methacrylate) macromers include ELVACITE 2010 (poly(methyl methacrylate)), 2042 (poly(ethyl methacrylate)), 2044 (poly(n-butyl methacrylate)), 2045 (poly(isobutyl methacrylate)), 2013 (methyl/n-butyl methacrylate copolymer), and 2046 (n-butyl/isobutyl methacrylate copolymer) acrylic resins. In some embodiments, the monofunctional poly(methacrylate) macromer may be a monofunctional poly(methyl methacrylate). Exemplary monofunctional poly(methyl methacrylate) macromers include ELVACITE 1010, 1020, 2041, 2051, and 3000 acrylic resins, available from Lucite International Canada.

Generally, the acrylic copolymers of the present disclosure comprise the polymerization reaction product of 50 to 92 wt. % of at least one alkyl (meth)acrylate monomer, 3 to 25 wt. % of at least one nitrogen-containing monomer, and 5 to 25 wt. % of at least one vinyl-functional poly(methacrylate) macromer. In some embodiments, collectively, the alkyl (meth)acrylate monomer(s), the nitrogen-containing monomer(s) and the mono-functional poly(methacrylate) macromer(s) compose at least 70 wt. %, e.g., at least 80 wt. %, or even at least 90 wt. % of the acrylic copolymer.

In some embodiments, the acrylic copolymer comprises at least 75 wt. %, e.g., at least 85 wt. %, or even at least 90 wt. % of the alkyl (meth)acrylate monomer(s). In some embodiments, the acrylic copolymer comprises 3 to 20 wt. %, e.g., 5 to 15 wt. % of the nitrogen-containing monomer(s). In some embodiments, the acrylic copolymer comprises 5 to 15 wt. %, e.g., 5 to 10 wt. % of the mono-functional poly(methacrylate) macromer(s).

In some embodiments, additional copolymers may be present. For example, in some embodiments, the acrylic copolymer may also include hydroxyalkyl(meth)acrylate comonomer(s). Exemplary hydroxyalkyl(meth)acrylates include hydroxyethyl(meth)acrylate, hydroxyproply(meth)acrylate and hydroxybutyl(meth)acrylate.

Acidic comonomers have commonly been used in the formulation of acrylate adhesives. As used herein, “acidic comonomer” refers to a comonomer comprising an acid group, e.g., a carboxylic acid group, a sulfonic acid group, a phosphonic acid group, or salts thereof. Examples of acidic monomers include, but are not limited to, (meth)acrylic acid, itaconic acid, fumaric acid, crotonic acid, citraconic acid, maleic acid, oleic acid, beta-carboxyethyl (meth)acrylate, 2-sulfoethyl methacrylate, styrene sulfonic acid, 2-acrylamido-2-methylpropanesulfonic acid, and vinylphosphonic acid.

In some embodiments, the acrylic copolymers of the present disclosure are substantially acid-free. Due to the presence of acidic impurities common in the available raw material supplies and typical manufacturing processes, it may be difficult to produce a completely acid-free acrylic copolymer. Thus, as used herein, “substantially acid-free” refers to copolymers that are acid free (i.e., containing no acidic comonomers), as well as those comprising less than 1 wt. %, e.g., no greater than 0.5 wt. %, or even no greater than 0.1 wt. % of an acidic comonomer. In contrast, acrylic copolymers formulated to include an acidic commoner generally include at least 1 wt. %, and more typically at least 2 wt. %, or even at least 5 wt. % acidic comonomer. These higher acidic comonomer contents are required to obtain the benefits associated with their inclusion in the acrylic copolymer.

Generally, the adhesives of the present disclosure comprise at least 93 wt. %, e.g., at least 95 wt. %, or even at least 98 wt. % of the acrylic copolymer. The adhesives may include minor components, i.e., components collectively accounting for less than 7 wt. %, e.g., less than 5 wt. %, or even less than 2 wt. % of the adhesive. Such minor components include those typically used in adhesive formulations such as fillers, dyes, pigments, stabilizers, and the like. Materials typically categorized as plasticizers or tackifiers may also be present in the minor components. However, in some embodiments, the adhesive comprises no greater than 5 wt. %, e.g., no greater than 3 wt. %, or even no greater than 1 wt. % tackifiers and/or plasticizers.

Generally, the adhesives of the present disclosure are intended to be free of flame retardants. However, in some embodiments, materials thought to be flame retardants may be present; thus, the adhesives of the present disclosure are substantially free of flame retardants. As used herein, “substantially free of flame retardants” refers to adhesives that are free of flame retardants (i.e., containing no flame retardants), as well as those comprising less than 2 wt. %, e.g., less than 1 wt. %, less than 0.5 wt. %, or even less than 0.2 wt. % based on the total weight of the adhesive. In some embodiments, the adhesives of the present disclosure comprise no greater than 1 wt. %, e.g., no greater than 0.5 wt. % of any one of mineral flame retardants, halogenated flame retardants, and organophosphorous flame retardants.

There are a variety of definitions and tests associated with flame retardancy. As used herein, a material is considered flame retardant if it meets with the requirements of FAR 25.853(a)(1)(ii). In particular, the material must be self-extinguishing when tested vertically; the average burn length may not exceed 8 inches (20.3 cm); the average flame time after removal of the flame source may not exceed 15 seconds; and drippings from the test specimen may not continue to flame for more than an average of 5 seconds after falling.

TABLE 1
Summary of materials used in the preparation of the examples.

| Name | Description | Source (Trade Name) |
|---|---|---|
| 2-EHA | 2-ethylhexyl acrylate | BASF |
| BA | n-butyl acrylate | BASF |
| AA | acrylic acid | |
| PIB-30 | polyisobutylene | BASF (OPPANOL B30) |
| ACM | acrylamide | Dianitrix |
| OACM | t-octyl acrylamide | |
| MACRO 10 | Polymethacrylate macromer | Lucite Intl. (ELVACITE 1010) |
| | (Mw approx. 7,000-10,000 g/mol) | |
| MACRO 20 | Polymethacrylate macromer | Lucite Intl. (ELVACITE 1020) |
| | (Mw approx. 12,000-15,000 g/mol) | |
| IOTG | isooctyl thioglycolate | Sigma Aldrich |
| Irg-651 | 2,2-Dimethoxy-1,2-diphenylethan-1-one | Ciba (IRGACURE 651) |
| Irg-1010 | Pentaerythritol tetrakis(3-(3,5-di-tert-butyl- | Ciba (IRGANOX 1010) |
| | 4-hydroxyphenyl)propionate) | |
| V-52 | 2,2-azobis(2,4-dimethylvaleronitrile) | DuPont (VAZO 52) |
| V-88 | 1,1′-Azobis(cyanocyclohexane) | DuPont (VAZO 88) |
| L-101 | 2,5-bis(t-butylperoxy)-2,5-dimethylhexane | Arkema (LUPERSOL 101) |
| L-130 | 2,5-di(t-butylperoxy)-2,5-dimethyl-3-hexyne | Arkema (LUPERSOL 130) |

### COMPARATIVE EXAMPLE CE-1

### Polyisobutylene

Polyisobutylene (PIB-30) having a molecular weight of about 200,000, was hot pressed at temperature of about 165° C. (329° F.) between two silicone liners to form a sheet with a thickness of about 50 microns (2 mils).

### COMPARATIVE EXAMPLE CE-2

### 2-EHA:AA (90:10)

2-EHA and AA were mixed at a weight ratio of 90:10. To this mixture 0.23 phr of a photoinitiator (Irg-651), and 0.04 phr of a chain transfer agent (IOTG) were added. The mixture was polymerized into adhesive using a method as described in U.S. Pat. No. 6,294,249 (Hamer et al.). After polymerization, the adhesive was hot pressed at 165° C. (329° F.) between two silicone liners to form a sheet with a thickness of about 50 microns.

### COMPARATIVE EXAMPLE CE-3

### 2-EHA:AA (95:5)

This sample was prepared as described above for CE-2, except the 2-EHA and AA were mixed at a weight ratio of 95:5.

### COMPARATIVE EXAMPLE CE-4

### 2-EHA:ACM (93:7)

The following components were charged to a glass jar: 92.20 grams (g) 2-EHA, 7.0 g ACM, 0.34 g of 5.88 wt. % IOTG in 2EHA, 0.10 g antioxidant (Irg-1010), and 7.0 g isopropanol (IPA). This solution was stirred in a water bath at 65° C. until all components were dissolved, then cooled to 50° C., at which time 0.48 g of 0.125 wt. % V-52 in 2-EHA was added with mixing. Next, 80 g of this mixture was transferred to a stainless steel reaction vessel VSP2 adiabatic reaction apparatus equipped with a 316 stainless steel can, available from Fauske and Associated, Inc., Burr Ridge, Ill.). The reactor was purged of oxygen while heating and pressurized with 414 kPa (60 psi) of nitrogen before reaching the induction temperature of 63° C. The polymerization reaction proceeded under adiabatic conditions to a peak reaction temperature of 120° C. A five gram sample was taken of the reaction mixture and the unreacted monomer was 67.5 wt. % based on the total weight of the mixture.

Next, the following components were charged to a glass jar: 0.5 g IOTG, 1.0 g V-52, 0.10 g V-88, 0.05 g L-101, 0.15 g L-130, and 48.20 g ethyl acetate. The solution was shaken in a reciprocating mixer to dissolve the solids, at which point 0.7 g of the resulting solution was added to sample in the stainless steel reaction vessel and stirred. The reactor was purged of oxygen while heating and then pressurized with 414 kPa (60 psi) of nitrogen gas before reaching the induction temperature of 59° C. The polymerization reaction proceeded under adiabatic conditions to a peak reaction temperature of 152° C. The mixture was isothermally held at 152° C. for thirty minutes before being drained into a jar. A sample of the final polymer (CE-4) and the unreacted monomer was 5.4% based on the total weight of the mixture.

### COMPARATIVE EXAMPLE CE-5

### 2-EHA:ACM:MACRO-10 (90:7:3)

The following components were added to a 5 liter stainless steel reaction vessel: 2685.6 g 2-EHA, 210 g ACM, 90 g MACRO-10, 3.0 g Irg-1010, and 210 g IPS. The mixture was heated to 60° C. while stirring, at which time 14.42 g of 0.125 wt. % solids V-52 in 2-EHA were added to the reactor and stirred. The reactor was purged of oxygen while heating and pressurized with 41 kPa (6 psi) of nitrogen gas before reaching the induction temperature of 63° C. The polymerization reaction proceeded under adiabatic conditions to a peak reaction temperature of 141° C. and was allowed to cool back to 60° C. before being depressurized. An aliquot was taken from the reaction mixture and the unreacted monomer was 52.4 weight percent based on the total weight of the mixture.

A solution was prepared by mixing 1.0 g V-52, 0.10 g V- 88, 0.05 g L-101, 0.15 g L-130, and 48.20 g ethyl acetate to a glass jar. The mixture was shaken in a reciprocating mixer to dissolve the solids. Then, 30.0 g of the resulting composition were stirred into the reactor. The reactor was purged of oxygen while heating and then pressurized with 41 kPa (6 psi) of nitrogen gas before reaching the induction temperature of 59° C. The polymerization reaction proceeded under adiabatic conditions to a peak reaction temperature of 134° C. The reactor was isothermally held at the peak temperature for one hour and then drained from the reaction vessel into silicone lined boxes. A sample was taken of the reaction mixture from this step (CE-5) and the unreacted monomer was 5.0 weight percent based on the total weight of the mixture.

### EXAMPLE EX-1

### 2-EHA:ACM:MACRO-10 (90:5:5)

The following components were added to a 5 liter stainless steel reactor: 2238 g 2-EHA, 125 g ACM, 125 g MACRO-10, 2.5 g Irg-1010, and 125 g IPA. The mixture was heated, while stirring, to 60° C. Then, 12.02 g of 0.125 wt % solids V-52 in 2-EHA was added to the reactor and stirred. The reactor was purged of oxygen while heating and pressurized with 41 kPa (6 psi) of nitrogen gas before reaching the induction temperature of 63° C. The polymerization reaction proceeded under adiabatic conditions to a peak reaction temperature of 160° C. and was allowed to cool back to 60° C. before being depressurized. An aliquot was taken from the reaction mixture and the unreacted monomer was 20.2 weight percent based on the total weight of the mixture.

A solution was prepared by mixing 1.0 g V-52, 0.10 g V-88, 0.05 g L-101, and 48.85 g ethyl acetate to a glass jar. The mixture was shaken in a reciprocating mixer to dissolve the solids. Then, 42.86 grams of the resulting composition were stirred into the reactor. The reactor was purged of oxygen while heating and then pressurized with 41 kPa (6 psi) of nitrogen gas before reaching the induction temperature of 59° C. The polymerization reaction proceeded under adiabatic conditions to a peak reaction temperature of 117° C. The reactor was isothermally held at the peak temperature for 1 hour and then drained from the reaction vessel into silicone lined boxes. A sample was taken of the reaction mixture from this step (EX-1) and the unreacted monomer was 2.8 weight percent based on the total weight of the mixture.

### EXAMPLE EX-2

### 2-EHA:ACM:MACRO-10 (86:7:7)

A solution was prepared by stirring 85.20 g 2-EHA, 7.0 g ACM, 7.0 g MACRO-10, 0.34 g of 5.88 wt % IOTG in 2-EHA, 0.10 g Irg-1010, and 7.0 g IPA within a glass jar and heating to 65° C. The solution was cooled to 50° C. A mixture of 0.48 g of 0.125 wt. % V-52 in 2-EHA was added and mixed. An aliquot of 80 grams of the mixture was transferred to a stainless steel reactor (described in CE-4). The reactor was purged of oxygen while heating and pressurized with 414 kPa (60 psi) of nitrogen gas before reaching the induction temperature of 63° C. The polymerization reaction proceeded under adiabatic conditions to a peak reaction temperature of 148° C. A 5.0-gram aliquot was taken from the reaction mixture and the unreacted monomer was 37.0 weight percent based on the total weight of the mixture.

A solution was prepared by mixing 1.0 g V-52, 0.10 g V-88, 0.05 g L-101, and 48.85 g ethyl acetate in a glass jar. The mixture was shaken on a reciprocating mixer to dissolve the solids. Then 0.7 g of the solution was stirred into the stainless steel reactor. The reactor was purged of oxygen while heating and then pressurized with 414 kPa (60 psi) of nitrogen gas before reaching the induction temperature of 59° C. The polymerization reaction proceeded under adiabatic conditions to a peak reaction temperature of 106° C. The mixture was isothermally held at that temperature for 30 minutes and then drained into a jar. A sample of the final polymer (EX-2) was taken and the unreacted monomer was 5.2 weight percent based on the total weight of the mixture.

### EXAMPLE EX-3

### 2-EHA:OACM:MACRO-10 (80:13:7)

A solution was prepared by stirring 79.52 g 2-EHA, 13.0 g OACM, 7.0 g MACRO-10, 0.10 g Irg-1010, and 5.0 g IPA within a glass jar and heating to 65° C. The solution was cooled to 50° C. A mixture of 0.48 g of 0.125 wt. weight percent V-52 in 2-EHA was added and mixed. An aliquot of 80 grams of the mixture was transferred to a stainless steel reactor (described in CE-4). The reactor was purged of oxygen while heating and pressurized with 414 kPa (60 psi) of nitrogen gas before reaching the induction temperature of 63° C. The polymerization reaction proceeded under adiabatic conditions to a peak reaction temperature of 149° C. A 5.0-gram aliquot was taken from the reaction mixture and the unreacted monomer was 27.8 weight percent based on the total weight of the mixture.

A solution was prepared by mixing 0.5 g IOTG, 1.0 g V-52, 0.10 g V-88, 0.05 g L-101, and 48.35 g ethyl acetate in a glass jar. The mixture was shaken on a reciprocating mixer to dissolve the solids. Then 0.7 gram of the solution was stirred into the stainless steel reactor. The reactor was purged of oxygen while heating and then pressurized with 414 kPa (60 psi) of nitrogen gas before reaching the induction temperature of 59° C. The polymerization reaction proceeded under adiabatic conditions to a peak reaction temperature of 112° C. The mixture was isothermally held at that temperature for 30 minutes and then drained into a jar. A sample of the final polymer (EX-3) was taken and the unreacted monomer was 5.9 weight percent based on the total weight of the mixture.

### EXAMPLE EX-4

### 2-EHA:BA:ACM:MACRO-20 (44:44:5:7)

A solution was prepared by stirring 42.72 g 2-EHA, 44.0 g BA, 5.0 g ACM, 7.0 g MACRO-20, 0.10 g Irg-1010, and 0.82 g of 2.44 weight percent hydroquinone monomethyl ether (MEHQ) in 2-EHA within a glass jar and heating to 65° C. The solution was cooled to 50° C. A mixture of 0.36 g of 0.125 weight percent V-52 in 2-EHA was added and mixed. An aliquot of 80 grams of the mixture was transferred to a stainless steel reactor (described in CE-4). The reactor was purged of oxygen while heating and pressurized with 414 kPa (60 psi) of nitrogen gas before reaching the induction temperature of 63° C. The polymerization reaction proceeded under adiabatic conditions to a peak reaction temperature of 204° C. A 5.0-gram aliquot was taken from the reaction mixture and the unreacted monomer was 19.5 weight percent based on the total weight of the mixture.

A solution was prepared by mixing 1.0 g V-88, 0.15 g L-101, and 48.85 g ethyl acetate in a glass jar. The mixture was shaken on a reciprocating mixer to dissolve the solids. Then 0.7 g of the solution was stirred into the stainless steel reactor. The reactor was purged of oxygen while heating and then pressurized with 414 kPa (60 psi) of nitrogen gas before reaching the induction temperature of 110° C. The polymerization reaction proceeded under adiabatic conditions to a peak reaction temperature of 187° C. The mixture was isothermally held at that temperature for 30 minutes and then drained into a jar. A sample of the final polymer (EX-4) was taken and the unreacted monomer was 4.6 weight percent based on the total weight of the mixture.

The compositions of the acrylate copolymers are summarized in Table 2.

TABLE 2
Composition of the acrylate copolymers.

| | Alkyl | | | | | | |
|---|---|---|---|---|---|---|---|
| | (meth)acrylate | | Nitrogen- | | Polymethacrylate | | |
| | monomer(s) | | containing | | macromer | | |
| | (wt. %) | | monomer | | (wt. %) | | AA |
| I.D. | 2-EHA | BA | type | wt. % | PMMA-10 | PMMA-20 | wt. % |
| CE-2 | 90 | — | — | — | — | — | 10 |
| CE-3 | 95 | — | — | — | — | — | 5 |
| CE-4 | 93 | — | ACM | 7 | — | — | — |
| CE-5 | 90 | — | ACM | 7 | 3 | — | — |
| EX-1 | 90 | — | ACM | 5 | 5 | — | — |
| EX-2 | 88 | — | ACM | 7 | 7 | — | — |
| EX-3 | 80 | — | OACM | 13 | 7 | — | — |
| EX-4 | 44 | 44 | ACM | 5 | — | 7 | — |

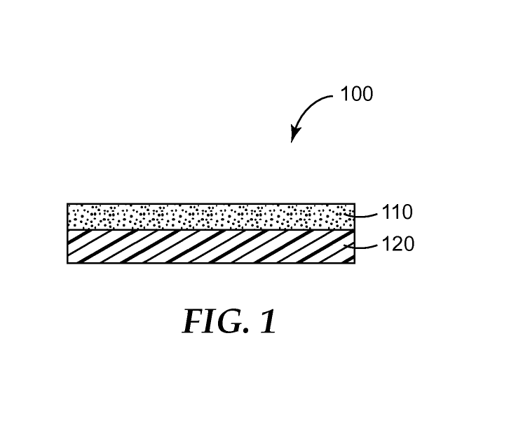

The adhesives of the present disclosure may be used in a wide variety of applications. For example, the adhesives can be used as unsupported film, e.g., a transfer tape. Adhesive films can also be prepared from the present adhesives using a support such as a scrim or mesh. Adhesive tapes may also be prepared such as those illustrated in FIG. 1.

Referring to FIG. 1, adhesive article 100 comprises flame retardant adhesive 110 bonded to substrate 120. As shown in FIG. 1, the adhesive may be bonded directly to a surface of the substrate. In some embodiments, the adhesive may be indirectly bonded to the substrate with one or more intervening layers, e.g., a primer layer. In some embodiments, a release liner may be disposed on the exposed surface of adhesive 110. The liner may then be removed prior to adhering adhesive article 100 to another substrate.

Generally, any known backing may be used including, e.g., films, foams, metallic foils, woven and nonwoven webs, and combinations thereof. Such substrates may include a flame retardant or may themselves be substantially free of flame retardants. Exemplary materials suitable for the backing include polymers. Exemplary polymers include such as polyesters, including aliphatic polyesters such as poly lactic acid; polyolefins, including polypropylene; polyurethanes, polyvinyl acetate, and the like. Natural materials such as cotton, and inorganic materials such as glass fibers may also be used. In some embodiments, multilayer substrates may be used. In some embodiments, woven or nonwoven webs may be used.

The adhesive articles may be used in a wide variety of applications. In some embodiments, the adhesive articles are adhered to a second substrate. Suitable substrates include, e.g. polymeric, metallic, and composite substrates. Exemplary metallic substrates include steel and aluminum. Exemplary composite substrates include carbon fiber and glass fiber composites.

Tape samples were prepared as follows. First, polyurethane (KRYSTALGRAN PN3429-108, available from Huntsman) was extruded at 165° C. onto a PET release liner at a thickness of about 150 microns (6 mils) to form a urethane tape backing. The adhesive samples were then laminated to the polyurethane backing, forming tape samples.

Burn Test Procedure. The following tests were conducted in accordance with FAR 25.853(a), Appendix F, Part I(a)1(ii) and Part I(b). Consistent with the test method, English units are reported with appropriate conversions provided in parentheses.

Test samples were cut into 4 inch by 12 inch (10.2 by 30.5 cm) strips. The strips were mounted onto a U-shaped aluminum panel having a central open channel 1 inch (2.5 cm) thick, 14 inches (35.6 cm) long, and 2 inches (5.1 cm) wide. This resulted in a sample test area 12 inches (30.5 cm) long and 2 inches (5.1 cm) wide. The panel mounted sample was suspended in an oven 1.5 inches (3.8 cm) above a flame. The sample was exposed to the flame for 12 seconds.

Self-extinguishing was noted. The total burn was recorded as the time from ignition of the sample until complete extinguishment. The burn length and presence or absence of dripping and there burn behavior were recorded. The results are summarized in Table 3.

TABLE 3
Burn test results.

| | Total | Test | Burn | Particle | | FAR |
|---|---|---|---|---|---|---|
| | Burn | Burn | Length | Burn | | 25.853 |
| | time | time | inch | time | Drips | pass/ |
| I.D. | seconds | seconds | (cm) | seconds | count | fail |
| CE-1 | 23 | 11 | >8 (>20) | >5 sec, large | 0 | Fail |
| | | | | flame | | |
| CE-2 | N/A* | N/A* | >8 (>20) | >5 sec. | N/A* | Fail |
| CE-3 | 13 | 1 | >8 (>20) | many at 1 sec.; | 0 | Fail |
| | | | | one at >5 sec. | | |
| CE-4 | 11 | 0 | 3.1 (7.9) | many at 1 sec.; | 0 | Fail |
| | | | | one >>5 sec. | | |
| CE-5 | 11 | 0 | 4.0 (10) | most 1-2 sec.; | 0 | Fail |
| | | | | few >5 sec. | | |
| EX-1 | 9 | 0 | 3.4 (8.6) | few; all 1-3 sec. | 0 | Pass |
| EX-2 | 14 | 2 | 3.5 (8.9) | few; all 1-3 sec. | 0 | Pass |
| EX-3 | 12 | 0 | 3.6 (9.1) | few; all 1-3 sec. | 0 | Pass |
| EX-4 | 7 | 0 | 4.0 (10) | few; all 1-3 sec. | 0 | Pass |

(*Sample CE-2 was not self-extinguishing.)

Adhesion Procedure. Adhesive laminated to primed PET were cut into samples 15.2 cm (6 inches) long by 1.3 cm (0.5 inch) wide and applied to an Al2024 panel, a composite panel with a glass fiber surface, and a composite panel with a carbon fiber surface. The samples were applied at 30.5 cm per minute (12 inches per minute) using a 2 kilogram rubber roller. The 180 degree peel force was measured at 30.5 cm per minute (12 inches per minute). The reported value represents the average of three measurements. The results are reported in Table 4.

TABLE 4
Peel adhesion results reported in N/cm (oz/0.5 inch).

| I.D. | Al2024 | Glass Fiber | Carbon Fiber |
|---|---|---|---|
| CE-4 | 6.2 (28) | 9.9 (45) | 8.8 (40) |
| CE-5 | 7.7 (35) | 7.5 (34) | 8.8 (40) |
| EX-1 | 6.6 (30) | 9.7 (44) | 10.1 (46) |
| EX-2 | 4.4 (20) | 7.0 (32) | 6.2 (28) |
| EX-3 | 4.6 (21) | 5.1 (23) | 5.1 (23) |
| EX-4 | 5.4 (24) | 7.4 (34) | 6.9 (31) |

Optical Properties Procedure. The optical transmittance and haze were measured according to ASTM 1003. Measurements were performed using a TCS PLUS Spectrophotometer, Model 8870, available from BYK-Gardner, Inc. CIE Standard Illuminant A was used. Percent luminous transmittance, b* parameter, and percent haze were recorded with no sample present in the spectrophotometer to establish a baseline transmission of 100%, b* of 0 and haze of 0%. A bare glass microscope slide was tested to provide a reference. Samples of the adhesives were prepared on a release liner and transferred to glass microscope slide. The samples were tested after removing the release liner. The results are summarized in Table 5.

TABLE 5
Optical property results.

| I.D. | % Transmission | % Haze | b* |
|---|---|---|---|
| Glass | 92.1 | 1.7 | 0.11 |
| CE-4 | 92.2 | 3.1 | 0.24 |
| CE-5 | 92.1 | 2.0 | 0.18 |
| EX-1 | 92.3 | 2.0 | 0.19 |
| EX-2 | 92.0 | 3.8 | 0.26 |
| EX-3 | 91.9 | 4.3 | 0.35 |
| EX-4 | 91.9 | 3.4 | 0.27 |

Various modifications and alterations of this invention will become apparent to those skilled in the art without departing from the scope and spirit of this invention.

What is claimed is:

1. A flame-retardant adhesive comprising
(a) at least 93 wt. % an acrylic copolymer comprising the polymerization reaction product of
(i) 50 to 92 wt. % of at least one alkyl (meth)acrylate monomer,
(ii) 3 to 25 wt. % of at least one nitrogen-containing monomer,
(iii) 5 to 25 wt. % of at least one vinyl-functional poly(methacrylate) macromer, and
(iv) 0 to 1 wt. % of a carboxylic acid group containing monomer; and
(b) 0 to 2 wt. % of a flame retardant.

2. The flame-retardant adhesive of claim 1, wherein the adhesive comprises at least 95 wt. % of the acrylic copolymer.

3. The flame-retardant adhesive of claim 1, wherein the acrylic copolymer comprises at least 75 wt % of the alkyl (meth)acrylate monomer.

4. The flame-retardant adhesive of claim 1, wherein the acrylic copolymer comprises 5 to 20 wt. % of the nitrogen-containing monomer.

5. The flame-retardant adhesive of claim 1, wherein the acrylic copolymer comprises 5 to 15 wt. % of the vinyl-functional poly(methacrylate) macromer.

6. The flame-retardant adhesive of claim 1, wherein the acrylic copolymer comprises 0 to 0.5 wt. % of the carboxylic acid group containing monomer.

7. The flame-retardant adhesive of claim 1, wherein the adhesive comprises 0 to 0.5 wt. % of the flame retardant.

8. The flame-retardant adhesive of claim 1, wherein the acrylic copolymer comprises
(a) at least 98 wt. % an acrylic copolymer comprising the polymerization reaction product of
(i) at least 85 wt. % of the alkyl (meth)acrylate monomer,
(ii) 5 to 15 wt. % of the nitrogen-containing monomer,
(iii) 5 to 10 wt. % of the vinyl-functional poly(methacrylate) macromer, and
(iv) 0 to 0.1 wt. % of the carboxylic acid group containing monomer; and
(b) 0 to 0.2 wt. % of a flame retardant.

9. The flame-retardant adhesive of claim 1, wherein at least one alkyl (meth)acrylate monomer is a C4-C8 alkyl (meth)acrylate monomer.

10. The flame-retardant adhesive of claim 1, wherein at least one nitrogen-containing monomer is acrylamide.

11. The flame-retardant adhesive of claim 1, wherein at least one vinyl-functional poly(methacrylate) macromer is a vinyl-functional poly(methyl methacrylate) macromer.

12. A flame-retardant tape comprising a substrate and the flame-retardant adhesive according to claim 1 bonded to at least a portion of at least one surface of the substrate.

13. The flame retardant tape of claim 12, wherein substrate comprises a urethane.

14. The flame retardant tape of claim 13, wherein tape passes FAR 25.853 when tested according to the Burn Test Procedure.
